(19) United States
(12) Patent Application Publication
(10) Pub. No.: US 2012/0139292 A1
(43) Pub. Date: Jun. 7, 2012

(54) MOTOR VEHICLE AND METHOD FOR THE PRODUCTION OF A MOTOR VEHICLE

(75) Inventors: Bernhard HOFER, Graz (AT); Sabine Bernhard, Kalsdorf (AT)

(73) Assignee: MAGNA STEYR FAHRZEUGTECHNIK AG & CO KG, Graz (AT)

(21) Appl. No.: 13/313,204

(22) Filed: Dec. 7, 2011

(30) Foreign Application Priority Data
Dec. 7, 2010 (DE) DE 102010053666.0

(51) Int. Cl. B62D 23/00; B23P 17/00

(52) U.S. Cl. 296/181.1; 29/897.2

(57) ABSTRACT

A motor vehicle and a method of producing a motor-vehicle which can be used in a flexible way. The method can include at least one of: painting a base frame using a cathodic dip painting process; producing a chassis by attaching a drive train, a running gear assembly and an electrical system to the painted base frame; attaching equipment components for an interior of the motor vehicle to the chassis in order to form an equipped chassis; painting a top coating of upper body shell modules; producing an upper body module assembly from each upper body shell module by attaching a module electrical system for at least one of each respective upper body shell module and at least one module equipment component; and then attaching via at least one of adhesive bonding and screwing, the upper body module assemblies to the equipped chassis.

### CROSS-REFERENCE TO RELATED APPLICATIONS

The present application claims priority under 35 U.S.C. §119 to German Application No. DE 10 2010 053 666.0 (filed on Dec. 7, 2010), which is hereby incorporated by reference in its entirety.

### FIELD OF THE INVENTION

The present invention relates to a method for the production of a motor vehicle and to a motor vehicle.

### BACKGROUND OF THE INVENTION

Motor vehicles and methods for the production thereof are well known.

### SUMMARY OF THE INVENTION

An object of the present invention is to provide a motor-vehicle production method which can be used in a flexible way and by way of which it is also possible to reduce production costs, and to provide an enhanced motor vehicle.

In accordance with embodiments of the invention, a method for producing a motor vehicle can include at least one of the following steps: painting a base frame using a cathodic dip painting process; producing a chassis by attaching a drive train, a running gear assembly and an electrical system to the painted base frame; attaching equipment components for an interior of the motor vehicle to the chassis in order to form an equipped chassis; painting a top coating of upper body shell modules; producing an upper body module assembly from each upper body shell module by attaching a module electrical system for at least one of each respective upper body shell module and at least one module equipment component; and then attaching via at least one of adhesive bonding and screwing, the upper body module assemblies to the equipped chassis.

In the method in accordance with embodiments of the invention, the upper body module assemblies and the equipped chassis are produced separately from each other and are combined to form the motor vehicle by attaching the upper body module assemblies to the equipped chassis. This makes it possible to produce the upper body module assemblies and the equipped chassis on separate production lines, which can thus be kept short and hence are less complex. The individual upper body module assemblies can also be produced on different production lines or, alternatively, can be produced on one production line, at least regarding individual work steps, e.g., painting. Consequently, it is possible to keep each of the production lines for the upper body module assemblies correspondingly short as well. In this context, an upper body shell module can be formed by one or more upper body shell parts, in particular upper body shell parts connected to each other, such as the module electrical system and the module equipment components.

The chassis with the vehicle frame and the drive train arranged thereon, the running gear assembly and the vehicle electrical system can also be referred to as a “rolling chassis” since the wheels attached to the running gear assembly allow the chassis to be moved.

One advantage of the method in accordance with embodiments of the invention is that the upper body module assemblies can be produced simultaneously and also simultaneously with the equipped chassis. As a result, it is possible to reduce the overall time required for the production of the motor vehicle. The upper body module assemblies can be attached to the equipped chassis by cold joining methods, e.g., by adhesive bonding and/or screw fastening.

By dip painting the base frame, on the one hand, and top coating the upper body shell modules, on the other hand, it is possible to optimize the respective painting operations from the point of view of costs without having to accept sacrifices in the quality of the paint finishes.

The abovementioned vehicle electrical system includes electrical and/or electronic components of the vehicle electrics or vehicle electronics which are arranged on the chassis. Components of this kind include cable harnesses running in the area of the chassis.

The equipment components, especially those for the vehicle interior, can include any component(s) which can be integrated particularly easily into the vehicle by attachment to the chassis. The equipment components can include, by way of example, a cockpit or dashboard, vehicle seats, carpets for the interior and a steering system.

The module electrical system of an upper body module assembly can include the electrical and/or electronic components which belong to the respective upper body module assembly or are provided for integration into the respective upper body module assembly. For example, a module electrical system of a door module assembly described below in greater detail can include an electric window lifter and a door lighting system.

The module equipment component can include other components of an upper body module assembly, such as trim panels.

The vehicle base frame is preferably of variable configuration, in particular being designed for different wheel bases and/or wheel sizes and/or overhangs and/or vehicle widths, and/or has a variable longitudinal member spacing, and the vehicle base frame is adjusted to the drive train to be attached and/or to the running gear assembly to be attached. This enables the vehicle base frame to be adjusted to the respective vehicle model to be produced or vehicle type to be produced.

In accordance with an embodiment of the invention, the underside of the vehicle base frame faces upwards during the mounting of the drive train and/or of the running gear assembly and/or of the vehicle electrical system. This enables the components to be arranged on the vehicle base frame more easily and quickly. Moreover, the chassis can be turned before the attachment of the equipment components so that the underside of the vehicle base frame faces downwards. This likewise enables the equipment components to be mounted more easily.

Provision can also be made to turn the vehicle base frame one or more times during the mounting of the drive train and/or of the running gear assembly and/or of the vehicle electrical system to enable elements of the drive train, of the running gear assembly and/or of the vehicle electrical system to be mounted from the top or bottom of the vehicle base frame, as appropriate, depending on what is better in terms of access.

The upper body shell modules are preferably produced in parallel with the vehicle base frame and/or are painted in a joint painting operation. This allows a further optimization of the production process, especially as regards the overall time required for the production of the motor vehicle, and as regards the costs arising. Accessibility during the mounting of the individual modules is also enhanced over a conventional vehicle architecture. For example, a belt can be inserted more easily into a side wall shell module.

The upper body shell modules preferably include a left-hand side wall shell, a right-hand side wall shell, a roof shell, a rear end shell, a shell for a front left-hand door, a shell for a front right-hand door, optionally a shell for a rear left-hand door, optionally a shell for a rear right-hand door, and a tailgate shell. The parts mentioned are relatively easy to produce, optionally at different locations, and relatively easy to process.

In accordance with embodiments of the invention, the upper body module assemblies include a left-hand and a right-hand side wall module assembly, a roof module assembly, a rear end module assembly, at least one door module assembly and a tailgate module assembly.

Important components of the motor vehicle which have not already been attached to the chassis are thus implemented as upper body module assemblies, which are then attached to the equipped chassis.

As already mentioned above, each individual upper body module assembly has the associated module electrical system and/dr the associated module equipment component. Each upper body module assembly can thus have the respective components or parts required to provide the respective functionality assigned to the corresponding upper body module assembly. There is therefore little need or no longer any need to add further components or parts to the upper body module assemblies once they have been arranged on the equipped chassis, leading to simplification of the production method and to a reduction in the overall production time.

It is particularly preferable that the left-hand and the right-hand side wall module assemblies include the shell for the left-hand and the right-hand side walls, respectively, and pillar trim panels attached thereto and/or side wall electrical components attached thereto. Moreover, the roof module assembly preferably has the roof shell with a roof liner attached thereto and/or interior lighting elements attached thereto. It is further preferably that the rear end module assembly has the rear end shell with a rear cover panel arranged thereon and/or a loading sill arranged thereon and/or a trim panel arranged thereon. Furthermore, it is preferably that each door module assembly has a door shell with a trim panel arranged thereon and/or door electrical systems arranged thereon. Yet and still it is also preferably that the tailgate module assembly include the tailgate shell with a trim panel arranged thereon and/or tailgate electrical systems arranged thereon.

Accordingly, the roof module assembly, for example, includes the interior lighting elements as a module electrical system and the roof liner as a module equipment component, these being attached to the roof shell as the upper body shell module.

In accordance with another embodiment, each door module assembly has an upper body shell module in the form of a door shell with a module equipment component in the form of a trim panel arranged thereon and/or with a module electrical system in the form of a door electrical system arranged thereon. As already mentioned above, the individual upper body module assemblies can accordingly form functional units, allowing the production of the motor vehicle to be simplified and the time required for production to be shortened.

In accordance with another embodiment, the left-hand and the right-hand side wall module assembly, the roof module assembly, the rear end module assembly, the tailgate module assembly and the door module assemblies are secured on the equipped chassis by adhesive bonding and/or screw fastening. The use of adhesive makes it possible to enhance the acoustic properties of the interior of the motor vehicle since adhesive has a noise-attenuating effect. Moreover, it is possible to achieve a reduction in weight as compared with the use of screws.

It is particularly preferable if cover panels, in particular for covering screw fastening and/or adhesive bonding locations, are arranged between adjacent upper body module assemblies in order, for example, to enhance the visual or aesthetic impression made by the body.

It is possible for windowpanes and/or a front module and/or bumper covers and/or wheel arches to be fitted on the equipped chassis after the attachment of the upper body module assemblies. After the attachment of the upper body module assemblies, the motor vehicle is thus complete.

Provision can also be made for the vehicle electrical system to have at least one coupling point for each module electrical system, via which the respective module electrical system is connected electrically to the vehicle electrical system, in particular after the attachment of the upper body module assemblies to the equipped chassis. This makes it possible to electrically connect the module electrical systems of the upper body module assemblies quickly and easily to the vehicle electrical system.

It is preferable if the upper body module assemblies are attached to the equipped chassis and connected to one another in such a way that the stiffness of the chassis is increased. Since the upper body module assemblies thus bring about an increase in stiffness, the vehicle base frame can be designed with a lower stiffness, resulting in a weight saving in comparison with frame-type construction.

In accordance with another embodiment of the invention, a motor vehicle is provide that includes at least one of the following: a chassis with a painted vehicle base frame, on which a drive train, a running gear assembly and a vehicle electrical system are arranged; equipment components for the vehicle interior, which are arranged on the chassis and, with the chassis, form an equipped chassis; and a plurality of upper body module assemblies, each with a painted upper body shell module, on which a module electrical system for the respective upper body shell module and/or a module equipment component for the respective upper body shell module is/are arranged each upper body module assembly being attached to the equipped chassis via at least one of an adhesive bond and screw.

An advantageous feature of the motor vehicle in accordance with embodiments of the invention is that, especially by virtue of the production process, it has a self-supporting body which is not decoupled from the vehicle base frame. There is therefore less need, or none at all, for rubber supports between the vehicle base frame and the components arranged thereon, with a corresponding gain of additional installation space.

Each upper body shell module can be composed of several different materials. Moreover, various types of upper body shell modules can be composed of different materials. In particular, the upper body shell modules and/or the vehicle base frame are composed of the optimum material or material matrix for the respective functionality thereof for example, e.g., of steel, aluminium, plastic and/or a composite material.

The individual upper body module assemblies can also include several materials since the respective upper body shell module, the respective module electrical system and/or the respective module equipment component, in particular, can consist of different materials. The upper body module assemblies arranged on a motor vehicle can therefore differ in terms of the materials of which they are each composed. The overall vehicle is thus composed of a “material mix” which can be optimized in terms of vehicle weight, for example, by appropriate choice of materials without having to accept significant impairments of stability, for example.

### BRIEF DESCRIPTION OF THE DRAWINGS

The invention is described in more detail in the enclosed figures and drawings, which present an implementation example. The drawings demonstrate:

FIG. 1 illustrates a flow chart of the method in accordance with an embodiment of the invention.

FIG. 2 illustrates an equipped chassis in accordance with an embodiment of the invention.

FIG. 3 illustrates a motor vehicle having the equipped chassis from FIG. 2.

FIG. 4 illustrates a roof module assembly in accordance with an embodiment of the invention.

### DETAILED DESCRIPTION OF EMBODIMENTS

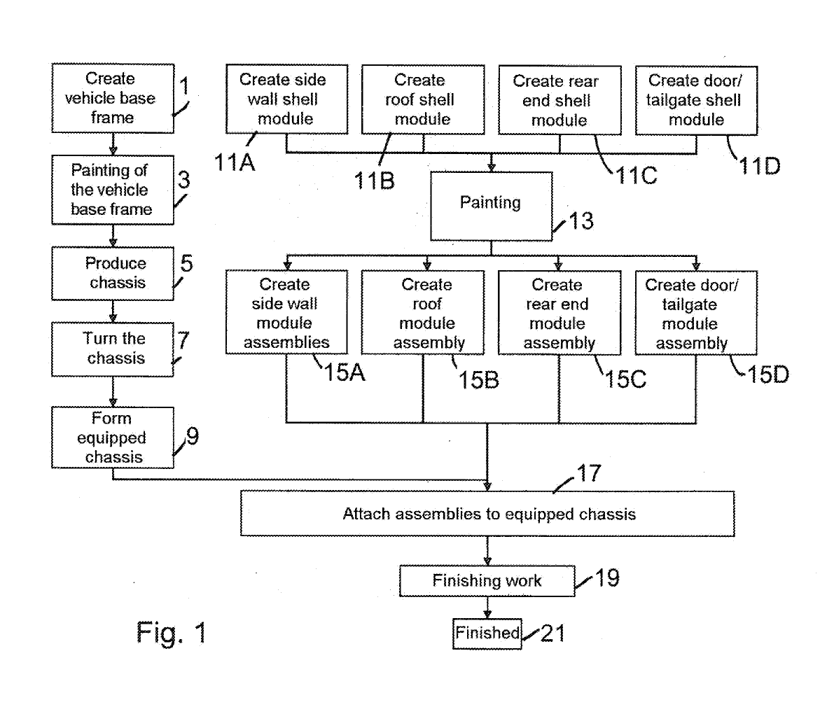

In accordance with the embodiment illustrated in FIG. 1 for the production of a motor vehicle, a vehicle base frame is created in step 1. The vehicle base frame forms the basis for the motor vehicle to be produced and is of variable configuration. This base frame can therefore be adapted to the envisaged wheelbase, wheel sizes, overhangs and envisaged vehicle width, depending on the vehicle type or vehicle model. The vehicle base frame also has a variable longitudinal member structure. It can therefore be adapted to the drive that is to be attached. It is thus possible, for example, for an all-wheel drive or a front-wheel or rear-wheel drive to be fitted in the vehicle base frame. Moreover, an internal combustion engine can be arranged lengthwise or transversely. A hybrid or electric drive can likewise be provided.

In step 3, the surface of the vehicle base frame is coated by a cathodic dip painting process. In step 5, a chassis is produced by attaching a drive train, a running gear assembly and a vehicle electrical system to the painted vehicle base frame. The flexible vehicle base frame is adjusted in such a way that the drive train and the running gear assembly can be fitted. The underside of the vehicle base frame faces upwards during the mounting of the drive train and/or of the running gear assembly and/or of the vehicle electrical system in order to simplify the respective mounting operation. The drive train can include, in particular, an engine, a transmission, a fuel feed system including a tank and an exhaust system. The running gear assembly can include, in particular, a front and a rear axle including the shock absorbers and the wheels. The vehicle electrical system includes, in particular, cable harnesses or cable looms or possibly control units or sensors, which are particularly easy to fit at this stage of the production process.

In step 7, the chassis is turned or otherwise manipulated to a different spatial orientation. This step can also be performed as an intermediate step within step 5, if, for example, it is easier to attach the drive train, the running gear assembly, the vehicle electrical system or individual components thereof to the vehicle base frame when the top of the latter is facing upwards. In particular, provision can also be made for the chassis to be turned backwards and forwards a plurality of times between various orientations in order to fit the above-mentioned systems in the chassis.

In step 9, an equipped chassis is formed by arranging equipment components, in particular components for the interior, such as a dashboard including a cockpit, vehicle seats and carpets, on the chassis. Moreover, a steering system can be fitted if parts of the steering system have not already been fitted together with the running gear assembly in step 5.

As illustrated in FIG. 1, upper body shell modules are created in steps 11A to 11D, which are carried out in parallel with steps 1 to 9. In step 11A, a left-hand side wall shell module and a right-hand side wall shell module are created. In step 11B, a roof shell module is created, and in step 11C a rear end shell module is created. In step 11D, a shell module for a front left-hand door, a shell module for a front right-hand door, optionally a shell module for a rear left-hand door, optionally a shell module for a rear right-hand door, and a tailgate shell module are created. It is also possible, in particular, for the individual steps 11A to 11D to be carried out at different locations or using different production lines, and they are therefore mutually independent.

In step 13, the upper body shell modules are top-coated together, in particular for the sake of reducing costs.

In steps 15A to 15D, an upper body module assembly is produced from each upper body shell module. In step 15A, a left-hand and a right-hand side wall module assembly are formed from the left-hand and the right-hand side wall shell modules, respectively, by attaching pre-cabling and pillar trim panels. In step 15B, a roof module assembly is formed from the roof shell module by attaching a roof liner and interior lighting elements. In step 15C, a rear end module assembly is formed from the rear end shell module by attaching a rear cover panel, a loading sill and trim panels. In step 15D, a door module assembly is in each case formed from one of the door shell modules by attaching an interior trim panel and door electrical systems, e.g., for a window lifter and a door locking system. Moreover, a tailgate module assembly is formed from the tailgate shell module by arranging a trim panel and tailgate electrical systems, e.g., for a tailgate locking system and a tailgate interior lighting system.

As illustrated in FIG. 1, steps 15A to 15D are carried out in parallel, thereby achieving a reduction in the overall time required to produce the motor vehicle. Moreover, the upper body module assemblies formed in steps 15A to 15D are combined with the equipped chassis in step 17 by attaching the upper body module assemblies to the equipped chassis. In this process, the upper body module assemblies are adhesively bonded and/or screwed to the corresponding points on the chassis, in particular in such a way that the stiffness of the chassis is increased.

In step 19, cover panels for covering screw fastening and/or adhesive bonding locations are arranged between adjacent upper body module assemblies. Moreover, window panes and a front module, wheel arches, bumper covers and other electrical systems are fitted.

The vehicle electrical system fitted in step 5 has at least one coupling point for each module electrical system. In step 19, the respective module electrical system is connected electrically to the vehicle electrical system via the respective coupling point. In step 21, the vehicle is completed.

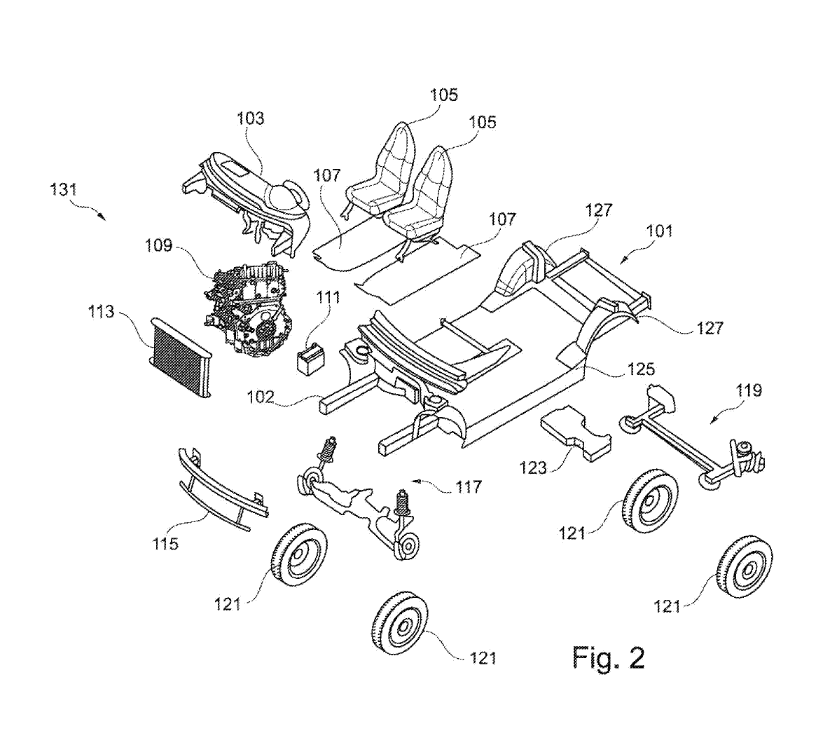

As illustrated in FIG. 2, a chassis 101 is produced by attaching a drive train and a running gear assembly to a painted vehicle base frame 102. The drive train includes a drive 109, a tank 123 and elements of an exhaust system. The running gear assembly includes a front axle 117 with the associated suspension systems and a rear axle 119 with the associated suspension systems and wheels 121. To form an equipped chassis 131, the following equipment components are furthermore attached, to the chassis 101: a dashboard 103, vehicle seats 105, carpets 107, in particular underneath the seats 105, a radiator 113 and a bumper cross member 115. A floor 125 for the interior is furthermore secured on the chassis 101. The above list of parts used to form the equipped chassis 131 is not exhaustive but is used simply for illustration. Indeed, further components, depending especially on the motor vehicle model to be produced, can be used.

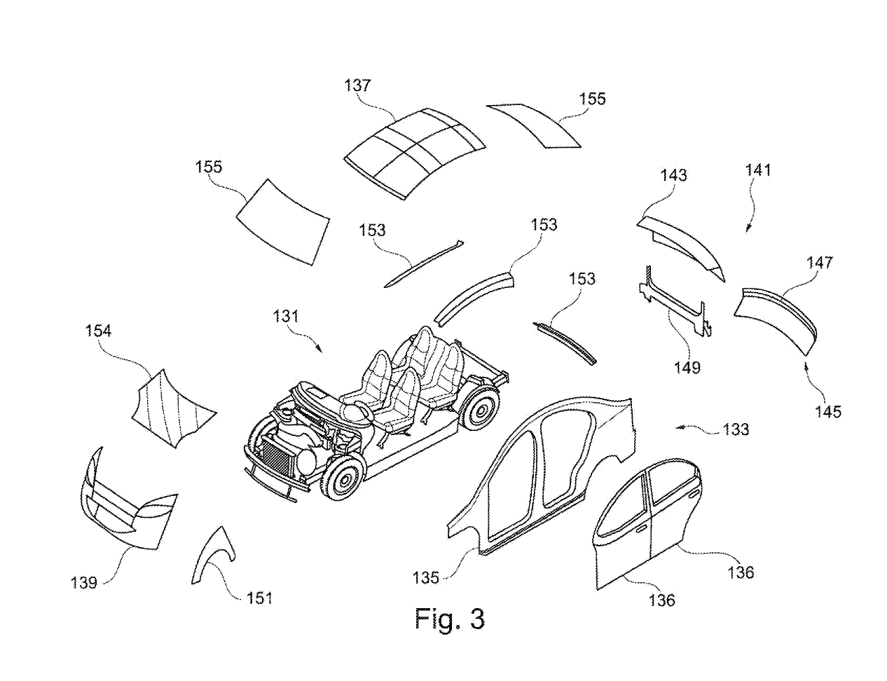

As illustrated in FIG. 3, the equipped chassis 131 is used to produce the motor vehicle by attaching upper body module assemblies. During this process, a left-hand side wall module assembly 133 that includes a left-hand side wall shell module 135 and trim panels and pre-cabling (not illustrated) arranged thereon is arranged on the left-hand side of the equipped chassis 131. In a corresponding way, a right-hand side wall module assembly (not illustrated) is arranged on the right-hand side of the chassis 131. Door module assemblies 136, each including a door shell module with trim elements and electrical systems arranged thereon, are arranged on the left-hand side wall module assembly 133. Corresponding door module assemblies (not illustrated) are also arranged on the right-hand side wall module assembly after the latter has been secured on the equipped chassis.

Moreover, a roof module assembly 137, a front skirt 139, a tailgate module assembly 141 with a tailgate 143 and trim panels arranged thereon, and a rear end module assembly 145 with a rear end shell module 149 and a loading sill arranged thereon are attached. Additional body trim panels, such as a lateral body element 151 for the left-hand front wheel house, and cover panels 153 in the area between adjacent upper body module assemblies, a bonnet 154, windowpanes 155 and a rear skirt 147, are also attached.

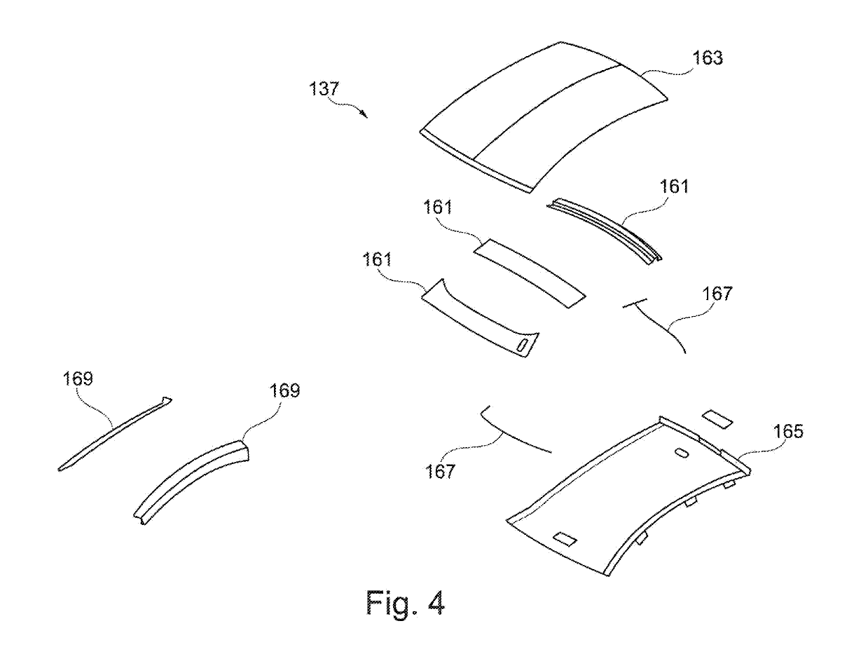

As illustrated in FIG. 4, the roof module assembly 137 is produced by securing roof frame elements 161 composed of steel or aluminium on a roof skin 163. It is possible for the roof skin 163 to be composed of steel, aluminium or plastic. A roof liner 165 and cable looms 167 for the interior lighting are furthermore arranged underneath the roof frame elements 161. Moreover, further assembly components are provided, such as the cover panels 169 illustrated in FIG. 4, in particular. As explained above with reference to FIG. 3, these are attached to the vehicle after the mounting of the roof module assembly 137 formed by components 161 to 167.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of producing motor vehicle, the method comprising:
painting a vehicle base frame;
producing a chassis by attaching a drive train, a running gear assembly and a vehicle electrical system to the painted vehicle base frame;
forming an equipped chassis by attaching equipment components to the chassis;
painting a top coating to upper body shell modules;
producing an upper body module assembly from each upper body shell module by attaching a module electrical system for at least one of each respective upper body shell module and at least one module equipment component; and then
attaching the upper body module assemblies to the equipped chassis via at least one of adhesive bonding and screw fastening.

2. The method of claim 1, wherein the vehicle base frame is of variable configuration.

3. The method of claim 1, wherein the vehicle base frame is configured for variable at least one of wheel bases, wheel sizes, overhangs, vehicle widths, and longitudinal member spacing.

4. The method of claim 1, wherein the vehicle base frame is adjustable in relation to at least one of the drive train and the running gear assembly.

5. The method of claim 1, wherein:
the underside of the vehicle base frame is spatially oriented upward during the attachment of at least one of the drive train, the running gear assembly, and the vehicle electrical system;
the chassis is spatial reoriented prior to attaching the equipment components such that the underside of the vehicle base frame faces downwards.

6. The method of claim 1, wherein at least one of:
the upper body shell modules are produced in parallel with the vehicle base frame; and
the upper body shell modules are painted in a joint painting operation.

7. The method of claim 1, wherein:
the upper body shell modules comprise a left-hand side wall shell module, a right-hand side wall shell module, a roof shell module, a rear end shell module, a shell module for a front left-hand door, a shell module for a front right-hand door and a tailgate shell module.

8. The method of claim 7, wherein:
the upper body shell modules comprise a shell module for a rear left-hand door and a shell module for a rear right-hand door.

9. The method of claim 1, wherein:
the upper body module assemblies comprise a left-hand and a right-hand side wall module assembly, a roof module assembly, a rear end module assembly, at least one door module assembly and a tailgate module assembly; and
the left-hand and the right-hand side wall module assemblies have a shell module for the left-hand and the right-hand side walls, respectively, and pillar trim panels attached thereto, and side wall electrical components attached thereto, the roof module assembly has a roof shell module with a roof liner attached thereto and interior lighting elements attached thereto, the rear end module assembly has a rear end shell module with a rear cover panel arranged thereon and a loading sill arranged thereon and a trim panel arranged thereon, each door module assembly has a door shell module with a trim panel arranged thereon and door electrical systems arranged thereon, and the tailgate module assembly comprises a tailgate shell module with, a trim panel arranged thereon and tailgate electrical systems arranged thereon.

10. The method of claim 9, wherein:
the left-hand and the right-hand side wall module assembly, the roof module assembly, the rear end module assembly, the tailgate module assembly and the door module assemblies are secured on the equipped chassis by at least one of adhesive bonding and screw fastening;
cover panels configured to cover the at least one of adhesive bonding and screw fastening locations, are arranged between adjacent upper body module assemblies.

11. The method of claim 1, wherein at least one of windowpanes, a front module, bumper covers and front wheel arches, are fitted on the equipped chassis after attaching the upper body module assemblies.

12. The method of claim 1, wherein:
the vehicle electrical system has at least one coupling point for each module electrical system, via which the respective module electrical system is connected electrically to the vehicle electrical system after attaching the upper body module assemblies to the equipped chassis.

13. The method of claim 1, wherein:
the upper body module assemblies are attached to the equipped chassis and connected to one another in order to increase stiffness of the chassis;
at least one each upper body shell module and the vehicle base frame is composed of a plurality of different materials;
various ones of the upper body shell modules are composed of different materials from one another.

14. The method of claim 1, wherein the painting comprises a cathodic dip painting process.

15. The method of claim 1, wherein the equipment components are attached to the vehicle interior.
wherein the upper body module assemblies are attached to the equipped chassis.

16. A motor vehicle comprising:
a equipped chassis including a chassis with a painted vehicle base frame, on which a drive train, a running gear assembly and a vehicle electrical system are arranged, and equipment components for the vehicle interior arranged on the chassis; and
a plurality of upper body module assemblies, each with a painted upper body shell module, on which at least one of a module electrical system and a module equipment component for a respective upper body shell module is arranged,
wherein each upper body module assembly is attached to the equipped chassis via adhesive bonding.

17. The motor vehicle of claim 16, wherein:
the vehicle base frame is of variable design, in particular being adaptable to different wheel bases and/or wheel sizes and/or overhangs and/or vehicle widths and/or having a variable longitudinal member spacing, and in that the vehicle base frame is adapted to the drive train fitted and/or to the running gear assembly fitted.

18. The motor vehicle of claim 16, wherein:
the upper body module assemblies comprise a left-hand and a right-hand side wall module assembly, a roof module assembly, a rear end module assembly, at least one door module assembly and a tailgate module assembly,
the left-hand and the right-hand side wall module assemblies have left-hand and right-hand side wall shell modules, respectively, and at least one of pillar trim panels and pre-cabling attached thereto,
the roof module assembly has a roof shell module with at least one of a roof liner and interior lighting elements attached thereto,
the rear end module assembly has a rear end shell module with at least one of a rear cover panel, a loading sill and a trim panel arranged thereon,
each door module assembly has a door shell module with at least one of a trim panel and door electrical systems arranged thereon; and
the tailgate module assembly has a tailgate shell module with at least one of a trim panel and tailgate electrical systems arranged thereon.

19. The motor vehicle of claim 16, wherein:
for each module electrical system, the vehicle electrical system has a coupling point for electrically connecting the respective module electrical system to the vehicle electrical system; and
each module electrical system has a terminal element corresponding to a respective coupling point, such that the terminal element is configured for connection to the coupling point in order to establish the electrical connection.
